(19) United States
(12) Patent Application Publication
(10) Pub. No.: US 2013/0050496 A1
(43) Pub. Date: Feb. 28, 2013

(54) SECURITY MONITORING METHOD AND APPARATUS USING AUGMENTED REALITY

(71) Applicant: Chi Yoon JEONG, Daejeon (KR)

(72) Inventor: Chi Yoon JEONG, Daejeon (KR)

(73) Assignee: Electronics & Telecommunications Research Institute, Daejeon (KR)

(21) Appl. No.: 13/550,769

(22) Filed: Jul. 17, 2012

(30) Foreign Application Priority Data
Aug. 25, 2011 (KR) 10-2011-0085348

(51) Int. Cl. G09G 5/00; H04N 7/18

(52) U.S. Cl. 348/159; 348/E07.085

(57) ABSTRACT

Disclosed is a security monitoring apparatus using augmented reality, including: an integrated event collector that collects events generated in a physical security region and an information security region; a security condition information generator that generates security condition information about each object to be monitored based on the collected events; and a security condition display unit that augments and displays the security condition information about the objects to be monitored existing in the videos photographed by cameras in the videos.

### CROSS-REFERENCE TO RELATED APPLICATIONS

This application claims priority to and the benefit of Korean Patent Application No. 10-2011-0085348 filed in the Korean Intellectual Property Office on Aug. 25, 2011, the entire contents of which are incorporated herein by reference.

### TECHNICAL FIELD

The present invention relates to a securing monitoring system, and more particularly, to an integrated security monitoring system in which a physical security monitoring system and an information security monitoring system are integrated.

### BACKGROUND ART

A monitoring security system is largely divided into CCTVs for preventing intrusion into a physical space, a physical security monitoring system managing entrance control systems, and an information security monitoring system for protecting a server, a host, a network infrastructure, and the like. In currently most enterprises or organizations, the physical security monitoring system and the information security monitoring system are independently operated.

Recently, the CCTVs or the entrance control systems are operated based on an IP network and therefore, are configured as an IT system type, but have inefficiency due to individual operation managements of a physical security region and an information security region.

Therefore, a technology of an integrated security monitoring system in which the physical security monitoring system and the information security monitoring system are integrated has been developed.

The integrated security monitoring system is a technology of integrating and analyzing security related events generated in the physical security region and the information security region to detect various threats and cope with the detected threats, which may be classified into a technology based on the information security monitoring system and a technology based on the physical security monitoring system.

The integrated security monitoring system based on the information security monitoring system mainly uses a method of generating a virtual space for management areas and mapping and representing analysis information of events to the corresponding space. In this case, however, it is difficult for a manager to intuitively recognize a place where threats are actually generated, and when objects existing in the actual space disappear, there is problems in that the actual objects and the objects existing in the virtual space are not accurately mapped to each other due to the existence of objects mapped to the virtual space, and the like.

The integrated security monitoring system based on the physical security monitoring system has not yet been sufficiently developed up to now. When threats are generated in the information security region, a method for displaying CCTV videos of the corresponding areas on a screen using the physical security monitoring system according to the related art has been mainly used. The integrated security monitoring system based on the physical security monitoring system provides only the video information about the corresponding areas, and as a result, it is difficult for a manager to immediately detect the detailed threat conditions and it takes much time to search for threat condition information and information necessary for coping with threats.

### SUMMARY OF THE INVENTION

The present invention has been made in an effort to provide a security monitoring apparatus and method capable of increasing efficiency of security monitoring in an integrated security monitoring system in which a physical security monitoring system and an information security monitoring system are integrated.

To this end, exemplary embodiments of the present invention use an augmented reality technology that has been interested recently. The augmented reality technology, which is a user interface technology of providing new information or increasing cognition of a user by representing videos photographed by cameras and additional information thereof together, has been mainly applied to advertisements, games, and the like. With the distribution of smart phones, the current augmented reality technology has been mainly developed as a technology of combining and representing user-customized information with actual videos in mobile terminals and has not been used for security monitoring.

An exemplary embodiment of the present invention provides a security monitoring apparatus using augmented reality, including: an integrated event collector that collects events generated in a physical security region and an information security region; a security condition information generator that generates security condition information about each object to be monitored based on the collected events; and a security condition display unit that augments and displays the security condition information about the objects to be monitored existing in the videos photographed by cameras in the videos.

The security condition information may include security risk levels.

The security monitoring apparatus may further include: an object information database that stores object information including positional information of each object to be monitored.

The security condition display unit may use the positional information of the cameras, camera motion information, and the object information stored in the object information database to identify the objects to be monitored existing in the videos photographed by the cameras.

The security condition information generator may include: an event aggregation module that aggregates and accumulates event data for each object to be monitored to generate statistical information; and a security condition determination module that uses the statistical information to calculate the security risk levels for each object to be monitored.

The security condition display unit may include: an object identification module that uses the positional information of the cameras, camera motion information, and the positional information of each object to be monitored to identify the objects to be monitored existing in the videos; and an augmented reality based display module that augments and displays the security condition information about the identified objects to be monitored in the videos.

Another exemplary embodiment of the present invention provides a security monitoring apparatus using augmented reality, including: an integrated event collector that collects events generated in a physical security region and an information security region; a security condition information generator that calculates security risk levels for each object to be monitored based on the collected events; and a security condition display unit that augments and displays the security risk levels for the objects to be monitored existing in the videos photographed by cameras in the videos.

The security condition information generator may aggregate and accumulate event data for each object to be monitored to generate statistical information and calculate the security risk levels for each object to be monitored using the statistical information.

The security condition display unit may simultaneously display a plurality of videos photographed by a plurality of cameras and augment and display the security risk levels for the objects to be monitored existing in the corresponding videos for each video in the corresponding videos.

The security condition display unit may change an arrangement order of the plurality of videos according to a total sum of the security risk levels for the objects to be monitored for each video.

The security condition display unit may differently display a size of at least one of the plurality of videos from those of other videos according to the total sum of the security risk levels for the objects to be monitored for each video.

Yet another exemplary embodiment of the present invention provides a security monitoring method using augmented reality, including: collecting events generated in a physical security region and an information security region; generating security condition information about each object to be monitored based on the collected events; and augmenting and displaying the security condition information about the objects to be monitored existing in the videos photographed by cameras in the videos.

The augmenting and displaying of the security condition information in the videos may include: using positional information of the cameras, camera motion information, and the positional information of each object to be monitored to identify the objects to be monitored existing in the videos photographed by the cameras; and augmenting and displaying the security condition information about the identified objects to be monitored in the videos.

The generating of the security condition information may include: aggregating and accumulating event data for each object to be monitored to generate statistical information; and using the statistical information to calculate the security risk levels for each object to be monitored.

In the augmenting and displaying of the security condition information in the videos, the plurality of videos photographed by the plurality of cameras may be simultaneously displayed and the security risk levels for the objects to be monitored existing in the corresponding videos for each video may be augmented and displayed in the corresponding videos.

In the augmenting and displaying of the security condition information in the videos, an arrangement order of the plurality of videos may be changed according to a total sum of the security risk levels for the objects to be monitored for each video.

In the augmenting and displaying of the security condition information in the videos, a size of at least one of the plurality of videos may be differently displayed from those of other videos according to the total sum of the security risk levels for the objects to be monitored for each video.

According to the exemplary embodiments of the present invention, it is possible to augment and display the security condition information related to the objects such as the security threat levels of the objects, and the like, in the videos photographed by the cameras in the integrated security monitoring system in which the physical security monitoring system and the information security monitoring system are integrated, such that the manager can immediately detect the threat conditions of the objects on the screen, thereby increasing the efficiency of security monitoring.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a configuration of a security monitoring apparatus using augmented reality according to an exemplary embodiment of the present invention.

FIG. 2 is a flow chart showing a security monitoring method using augmented reality according to an exemplary embodiment of the present invention.

FIG. 3 is a diagram showing a detailed configuration of an integrated event collector 110.

FIG. 4 is a diagram showing a detailed configuration of a security condition information generator 120.

FIG. 5 is a diagram showing an example of statistical information for each object stored in a memory map 123.

FIG. 6 is a flow chart showing a method for determining security conditions of a security condition determination module 124.

FIG. 7 is a diagram showing a detailed configuration of a security condition display unit 140.

FIGS. 8A to 8C are diagrams showing an example of a screen on which security conditions of objects according to the exemplary embodiment of the present invention are displayed.

FIGS. 9A and 9B are diagrams showing another example of a screen on which security conditions of objects according to the exemplary embodiment of the present invention are displayed.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention.

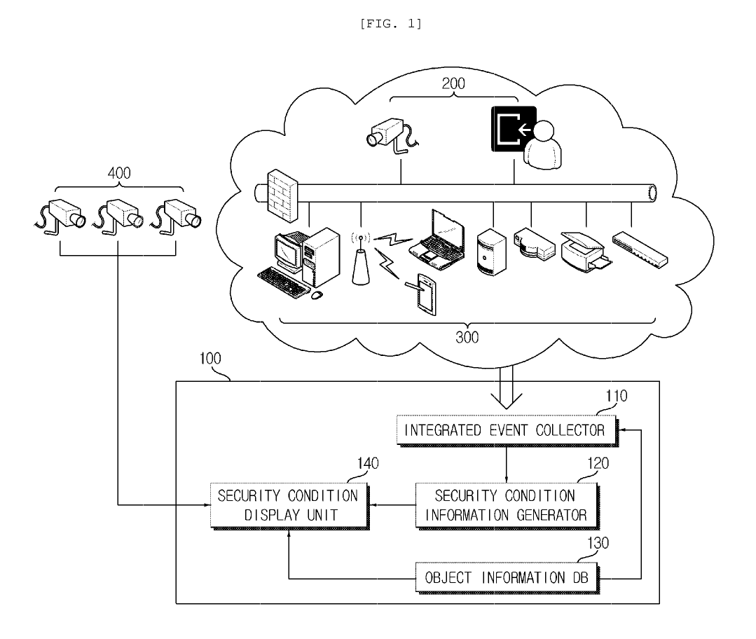

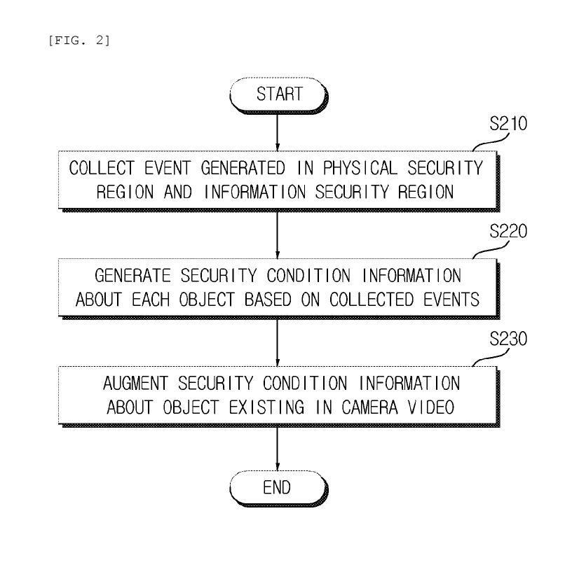

FIG. 1 is a diagram showing a configuration of a security monitoring apparatus using augmented reality according to an exemplary embodiment of the present invention, and FIG. 2 is a flow chart showing a security monitoring method using augmented reality according to an exemplary embodiment of the present invention. A security monitoring apparatus 100 according to an exemplary embodiment of the present invention is configured to include an integrated event collector 110, a security condition information generator 120, an object information database 130, and a security condition display unit 140.

The integrated event collector 110 collects events that are generated in a physical security region 200 and an information security region 300 (S210). The physical security region 200 is a region managed by the existing physical security monitoring system, which corresponds to CCTVs, entrance control systems, positioning systems, and the like. The information security region 300 is a region managed by the existing information security monitoring system, which corresponds to a server, a host, a network infrastructure, and the like. Examples of the events that are generated in the physical security region 200 may include an entrance control event, CCTV video information, analysis information of intelligent CCTV videos, positioning information, and the like. Examples of the events that are generated in the information security region 300 may include network traffic information, events generated in security equipments such as a firewall, intrusion detection equipment, and the like, a document output event, events such as wireless network traffic information, and the like. The integrated event collector 110 collects and normalizes various events and refers to the object information database 130 to add information about a position at which the corresponding events are generated and owner information of the corresponding objects to the event information and deliver the added information to the security condition information generator 120.

The security condition information generator 120 determines the security conditions for each object existing within a security monitoring zone based on the events collected in the integrated event collector 110 and generates the security condition information (S220). Herein, the ‘object’, which is objects to be monitored in the integrated security monitoring system, may be a person, a host, various equipments, specific regions, or the like, which exist in the security monitoring zone. In the following specification, the ‘object’ means the objects to be monitored.

For example, when determining security conditions for a person, the security condition information generator 120 calculates the possibility that the person is likely to do threat behaviors such as important information spill, and the like, by analyzing all the events related to the person such as an event generated at the time of the entrance of a specific person, an event generated at the time of copying a document, an event generated at the time of accessing the database, and traffic information generated from the host owned by the person, and the like.

When determining the security conditions for the objects such as the host, various equipments, and the like, rather than for a person, the security condition information generator 120 calculates the possibility that the objects are likely to be threat means or threat targets by analyzing all the events related to the objects such as events related to operations to be performed by the objects, information about a person accessing the objects, traffic information about the objects, and the like. As such, the possibility that the corresponding objects are likely to do the threat behaviors or to be threat means or threat targets becomes the security risk levels for the corresponding objects.

The security condition information generator 120 generates the security condition information including the security risk level of the corresponding objects for each object. In the following specification, the ‘risk level’ of each object means the ‘security risk level’.

The object information database 130 means a repository that stores positional information of each camera 400 and information about each object existing within the security monitoring zone. The object information stored in the object information database 130 includes, for example, owners, users, positional information, and manufacturer information of each object, and the like.

The security condition display unit 140 uses the augmented reality technology and augments and displays the security condition information for the objects existing in the videos photographed by the cameras 400 so as to be mapped to the corresponding objects of the corresponding videos (S230). The security condition display unit 140 acquires the positional information of the cameras 400 and the camera motion information such as pan/tilt/zoom, and the like, to find out a region that is being currently photographed by the camera 400, uses the positional information about the objects stored in the object information database 130 to identify the objects existing in the region, and fetches the security condition information about the identified objects from the security condition information generator 120. The security condition display unit 140 uses the augmented reality technology to augment and display the security condition information about each object in the current camera videos. FIG. 1 shows that the cameras 400 are separated from the physical security region 200 for convenience. However, it can be appreciated that the cameras 400 are provided within the physical security region 200.

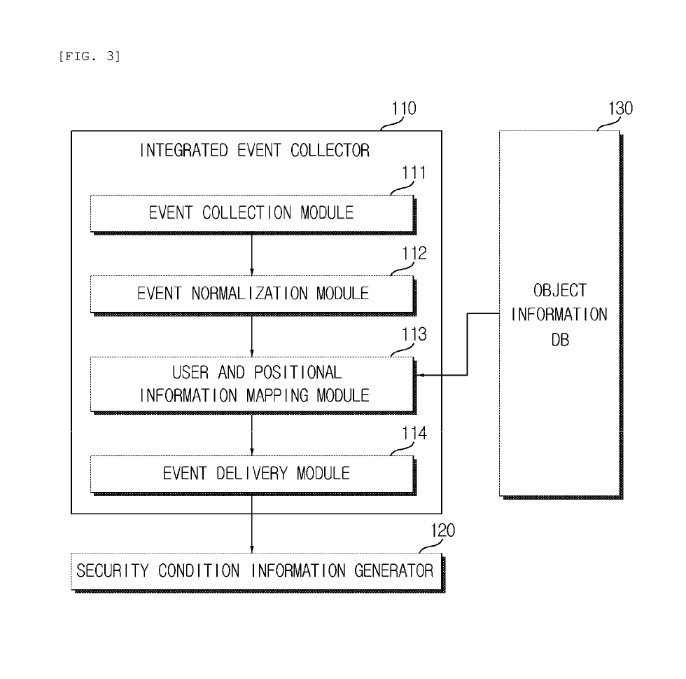

FIG. 3 is a diagram showing a detailed configuration of the integrated event collector 110. As shown in FIG. 3, the integrated event collector 110 is configured to include an event collection module 111, an event normalization module 112, a user and positional information mapping module 113, and an event delivery module 114.

The event collection module 111 uses network protocols such as TCP, UDP, and the like, and various protocols to serve to collect the events generated in the physical security region and the events generated in the information security region. The event normalization module 112 serves to extract only the information necessary to analyze the security conditions among the events collected in the event collection module 111. The user and positional information mapping module 113 uses owner information, user information, positional information, and the like, of each object stored in the object information database 130 to serve to add the information about position at which the corresponding events are generated and the related user information to the events. The event delivery module 114 serves to deliver the event information, in which the user and positional information is added to the normalized event, to the security condition information generator 120.

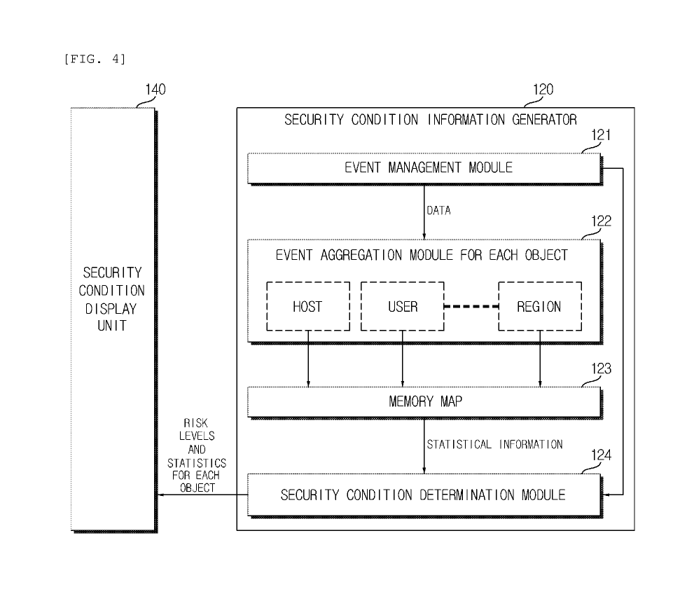

FIG. 4 is a diagram showing a detailed configuration of the security condition information generator 120. As shown in FIG. 4, the security condition information generator 120 is configured to include an event management module 121, an event aggregation module 122, a memory map 123, and a security condition determination module 124.

The security related event information may be classified into a non-processed event data and an alarm data generated by data analysis. The event management module 121 delivers the non-processed event data among the event information to the event aggregation module 122 for analysis and delivers the alarm data to the security condition determination module 124 for additional analysis.

The event aggregation module 122 serves to aggregate the delivered event data for each object. For example, the event aggregation module 122 aggregates the event data for each host, each user, or each region. The event aggregation module 122 accumulates the event data for each object to generate statistical information. For example, the statistical information about all the collected event data such as statistics of traffic generated by the corresponding hosts, statistics related to files accessed by the corresponding hosts, statistics related to the database accessed by the corresponding hosts, and the like, is generated for each host. The statistical information for each object generated as described above is stored in the memory map 123.

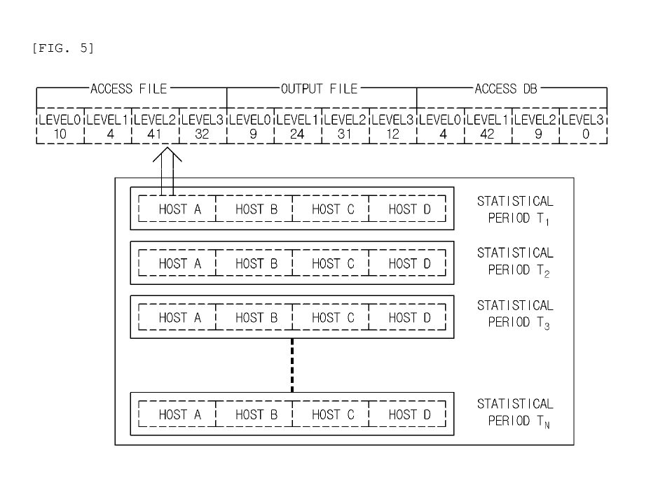

FIG. 5 is a diagram showing an example of the statistical information for each object stored in the memory map 123. Referring to FIG. 5, the objects correspond to four hosts A, B, C, and D. In the exemplary embodiment of the present invention, the statistical information is stored in a predetermined statistical period unit for each object. For example, as shown in FIG. 5, the statistical information during N statistical periods T₁, T₂, . . . , T_{N} for each host A, B, C, and D is stored in the memory map 123. As shown in FIG. 5, the statistical information about each host may be, for example, an access frequency for each file grade, an output frequency for each file grade, and an access frequency for each data grade stored in the database. The statistical information is updated in the predetermined statistical period unit, and the memory map 123 may be configured in a circular queue type. The security condition determination module 124 accesses and fetches the data stored in the memory map 123.

The security condition determination module 124 serves to determine the security conditions for each object by using the alarm data delivered from the event management module 121 and the statistical information stored in the memory map 123. FIG. 6 is a flow chart showing a method for determining security conditions of the security condition determination module 124.

The security condition determination module 124 collects the statistical information for each object from the memory map 123 (S610), calculates the risk level based on the rule about the collected statistical information (S620), and calculates the risk level for each object based on behaviors (S630). When calculating the risk level based on the rules, a mechanism for determining whether the statistical information is matched with the previously defined rules may be used and when calculating the risk level based on behaviors, a statistical based mechanism or a machine learning based mechanism may be used.

Meanwhile, the security condition determination module 124 receives the alarm data from the event management module 121 (S640) and normalizes the risk level of the alarm data having various ranges for each object so as to have the same range (S650). In this case, the security condition determination module 124 is configured so that the risk level calculated based on the rules, the risk level calculated based on behaviors, the normalized risk level of the alarm data have the same range.

The security condition determination module 124 integrates the risk level based on the statistical information for each object and the risk level of the alarm data to calculate the single integrated risk level for the corresponding object (S660). Upon calculating the integrated risk level, a mechanism based on a weighted sum of each risk level or a machine learning based mechanism may be used.

The security condition determination module 124 integrates the risk levels calculated for each object and other security condition information (statistical information, important event information, or the like) other than the risk levels to generate the security condition information for each object and deliver the generated security condition information to the security condition display unit 140 (S570).

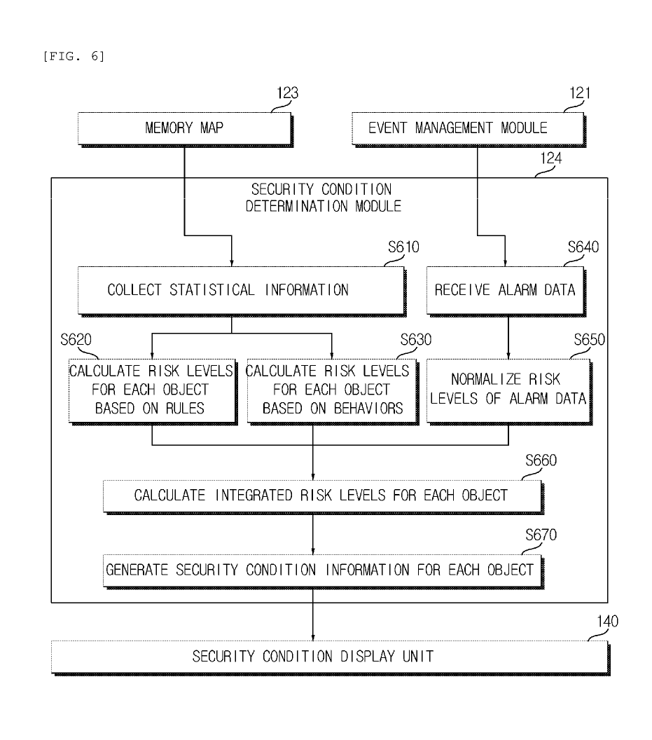

FIG. 7 is a diagram showing a detailed configuration of the security condition display unit 140. As shown in FIG. 7, the security condition display unit 140 is configured to include a camera motion information acquisition module 141, an object identification module 142, a camera video collection module 143, and an augmented reality based display module 144.

The camera motion information acquisition module 141 acquires the camera motion information from the cameras 400. The camera motion information, which is parameter information of the cameras such as pan/tilt/zoom, and the like, is used to calculate the region that is being currently photographed by the cameras 400. The camera motion information may be acquired based on hardware motion of the cameras 400 or acquired by analyzing the videos photographed by the cameras 400.

The object identification module 142 identifies objects existing on scenes photographed by the cameras 400 by using the positional information of the cameras 400, the camera motion information, and the positional information of each object stored in the object information database 130. In detail, the object identification module 142 fetches the positional information of the cameras from the object information database 130 and then, searches the objects on the scenes that is being currently photographed by the cameras 400 from the object information database 130 based on the fetched positional information and the camera motion information from the camera motion information acquisition module 141.

The camera video collection module 143 collects videos photographed by the cameras 400. The augmented reality based display module 144 serves to map the collected camera videos to the security condition information of the objects within the screen searched by the object identification module 142 and augment and display the security condition information of each object in the current camera videos. The videos in which the security condition information is augmented and displayed are provided to a manager through a screen display device 145.

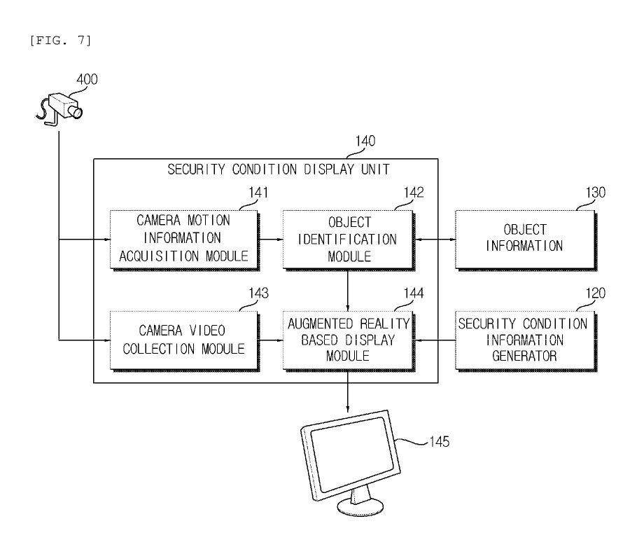

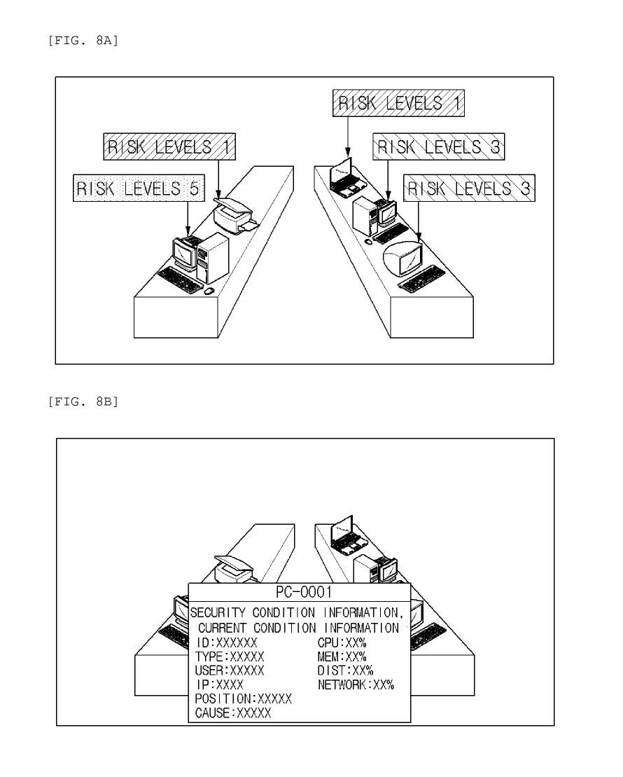

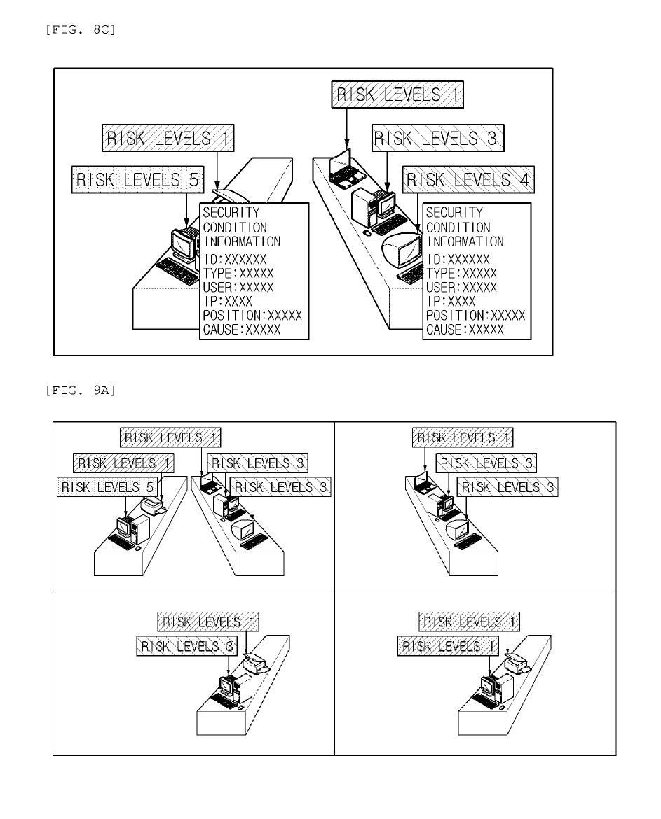

FIGS. 8A to 8C are diagrams showing an example of a screen on which security conditions of objects according to the exemplary embodiment of the present invention are displayed. FIG. 8A shows that risk levels 1, 3, and 5 for each object (PC, printer, notebook) within the videos photographed by the cameras are augmented and displayed. The augmented reality based display module 144 may be implemented to display the detailed information for the security conditions of the corresponding objects when the manager selects the specific objects or the risk levels of the specific objects from the corresponding screen, as shown in FIG. 8B. The augmented reality based display module 144 may display the risk levels and the detailed information about the security conditions together, as shown in FIG. 8C. In this case, the detailed information about the security conditions may be displayed together for only the objects having the risk levels of a specific value or more that are designated by the manager.

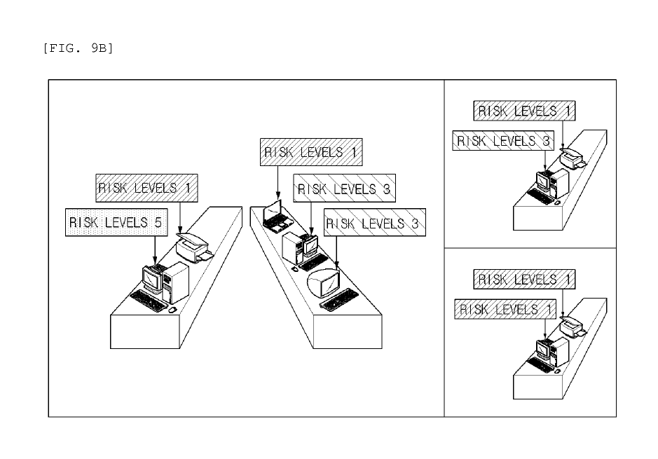

FIGS. 9A and 9B are diagrams showing another example of a screen on which security conditions of objects according to the exemplary embodiment of the present invention are displayed. The security condition display unit 140 may collect videos through the plurality of cameras, simultaneously display the videos photographed by several cameras through the single screen display device, and augment and display the security risk levels for the objects existing in the corresponding videos for each video in the corresponding videos. In this case, in the exemplary embodiment of the present invention, the security condition display unit 140 calculates a total sum of the risk levels of the objects existing in the videos of each camera. It is possible to increase the risk condition cognition of the manager by determining the importance of the videos according to a size of the total sum and varying the size of the videos such as the arrangement order of the videos according to the importance of the videos. FIG. 9A shows an example in which the arrangement order of the videos varies according to the importance of the videos, in which the videos corresponding to the total sum of the largest risk levels are arranged on the upper left of the screen and the videos corresponding to the total sum of the smallest risk levels are arranged on the lower right of the screen.

FIG. 9B shows an example in which the size of the videos varies according to the importance of the videos and shows that the videos corresponding to the total sum of the largest risk levels are larger displayed than other videos.

According to the exemplary embodiments of the present invention as described above, the manager can rapidly recognize the objects or the points where the threats occur by augmenting and displaying the security condition information such as the risk levels calculated for each object in the actually collected camera videos.

It is possible to provide an extendable structure appropriate for the integrated security monitoring by collecting various events and then aggregating and analyzing the events for each object in the integrated security monitoring system.

The manager can more rapidly recognize the intrusion accidents by controlling and displaying the arrangement, size, and the like, of the screen according to the importance of each video that is defined based on the risk levels of the objects existing in the videos collected through the cameras.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A security monitoring apparatus using augmented reality, comprising:
an integrated event collector that collects events generated in a physical security region and an information security region;
a security condition information generator that generates security condition information about each object to be monitored based on the collected events; and
a security condition display unit that augments and displays the security condition information about the objects to be monitored existing in the videos photographed by cameras in the videos.

2. The security monitoring apparatus of claim 1, wherein the security condition information includes security risk levels.

3. The security monitoring apparatus of claim 1, further comprising:
an object information database that stores object information including positional information of each object to be monitored.

4. The security monitoring apparatus of claim 3, wherein the security condition display unit uses the positional information of the cameras, camera motion information, and the object information stored in the object information database to identify the objects to be monitored existing in the videos photographed by the cameras.

5. The security monitoring apparatus of claim 2, wherein the security condition information generator includes:
an event aggregation module that aggregates and accumulates event data for each object to be monitored to generate statistical information; and
a security condition determination module that uses the statistical information to calculate the security risk levels for each object to be monitored.

6. The security monitoring apparatus of claim 1, wherein the security condition display unit includes:
an object identification module that uses the positional information of the cameras, camera motion information, and the positional information of each object to be monitored to identify the objects to be monitored existing in the videos; and
an augmented reality based display module that augments and displays the security condition information about the identified objects to be monitored in the videos.

7. A security monitoring apparatus using augmented reality, comprising:
an integrated event collector that collects events generated in a physical security region and an information security region;
a security condition information generator that calculates security risk levels for each object to be monitored based on the collected events; and
a security condition display unit that augments and displays the security risk levels for the objects to be monitored existing in the videos photographed by cameras in the videos.

8. The security monitoring apparatus of claim 7, wherein the security condition information generator aggregates and accumulates event data for each object to be monitored to generate statistical information and calculates the security risk levels for each object to be monitored using the statistical information.

9. The security monitoring apparatus of claim 7, wherein the security condition display unit simultaneously displays a plurality of videos photographed by a plurality of cameras and augments and displays the security risk levels for the objects to be monitored existing in the corresponding videos for each video in the corresponding videos.

10. The security monitoring apparatus of claim 9, wherein the security condition display unit changes an arrangement order of the plurality of videos according to a total sum of the security risk levels for the objects to be monitored for each video.

11. The security monitoring apparatus of claim 9, wherein the security condition display unit differently displays a size of at least one of the plurality of videos from those of other videos according to the total sum of the security risk levels for the objects to be monitored for each video.

12. A security monitoring method using augmented reality, comprising:
collecting events generated in a physical security region and an information security region;
generating security condition information about each object to be monitored based on the collected events; and
augmenting and displaying the security condition information about the objects to be monitored existing in the videos photographed by cameras in the videos.

13. The security monitoring method of claim 12, wherein the security condition information includes security risk levels.

14. The security monitoring method of claim 12, wherein the augmenting and displaying of the security condition information in the videos includes:
using positional information of the cameras, camera motion information, and the positional information of each object to be monitored to identify the objects to be monitored existing in the videos photographed by the cameras; and
augmenting and displaying the security condition information about the identified objects to be monitored in the videos.

15. The security monitoring method of claim 13, wherein the generating of the security condition information includes:
aggregating and accumulating event data for each object to be monitored to generate statistical information; and
using the statistical information to calculate the security risk levels for each object to be monitored.

16. The security monitoring method of claim 13, wherein in the augmenting and displaying of the security condition information in the videos, a plurality of videos photographed by a plurality of cameras are simultaneously displayed and the security risk levels for the objects to be monitored existing in the corresponding videos for each video are augmented and displayed in the corresponding videos.

17. The security monitoring method of claim 16, wherein in the augmenting and displaying of the security condition information in the videos, an arrangement order of the plurality of videos is changed according to a total sum of the security risk levels for the objects to be monitored for each video.

18. The security monitoring method of claim 16, wherein in the augmenting and displaying of the security condition information in the videos, a size of at least one of the plurality of videos is differently displayed from those of other videos according to the total sum of the security risk levels for the objects to be monitored for each video.
